(19) United States
(12) Patent Application Publication
(10) Pub. No.: US 2009/0128786 A1
(43) Pub. Date: May 21, 2009

(54) IMAGING SYSTEM WITH A MICROELECTROMECHANICAL LIGHT VALVE

(75) Inventors: David Foster Lieb, Dallas, TX (US); Jason Ryan Thompson, Dallas, TX (US); Terry Alan Bartlett, Dallas, TX (US); Steven Monroe Penn, Plano, TX (US); Andrew Ian Russell, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/942,237

(22) Filed: Nov. 19, 2007

(51) Int. Cl. G09G 3/36; G03B 21/28; G03B 21/14

(52) U.S. Cl. 353/121; 345/87; 353/99

(57) ABSTRACT

An imaging system comprises a light valve having an array of light valve pixels. For processing grayscale/color images, each light valve pixel represents a discrete grayscale level. During image processing, desired grayscales can be accomplished by imaging the light valve pixels onto the target such that the perceived grayscale of each target pixel is a sum of grayscales represented by a plurality of light valve pixels.

### TECHNICAL FIELD OF THE DISCLOSURE

The technical field of this disclosure relates to the art of digital imaging systems, and more particularly to the art of imaging systems with microelectromechanical light valves.

### BACKGROUND OF THE DISCLOSURE

A microelectromechanical light valve (hereafter light valve) is microelectromechanical device that is capable of varying the amount of incident light reaching a target (e.g. a screen and viewer's eyes) by deflecting the incident light from its path towards the target (e.g. a reflective light valve), or by blocking the light-path (e.g. a transmissive light valve), or by actively emitting light onto the target (self-light emission light valve).

A typical light valve in imaging systems comprises an array of individually addressable light valve pixels; and can be as a spatial light modulator (e.g. a micromirror-based spatial light modulator, a liquid-crystal display panel (LCD), a liquid-crystal-on-silicon (LCOS) based spatial light modulator, a silicon crystal reflective display panel (sXRD), and an interferometric modulator, etc.) and other types of light valves, such as self-light emitting light valves (e.g. organic light-emitting diode displays and plasma panels).

In most current display systems with light valves, which are a type of imaging systems, each image pixel (a pixel of a produced image on a display target) or a sub-group of adjacent image pixels corresponds to a light valve pixel. As a consequence, the total number of light valve pixels (which is referred to as resolution), as well as the aspect ratio (the ratio of number of pixels in rows to the number of pixels in columns of the pixel array), is expected to match the expected resolution (or aspect ratio) of the produced images. In other words, high resolution images will find it necessary in existing display system to employ light valves with high resolutions. However, light valves with high resolutions are often expensive due to complicated designs and fabrications.

Current display systems employing light valves produce desired color/gray images by sequentially illuminating the light valves with different colors of illumination light. The sequential colors of illumination light are often generated by a passing white light emitted from a standard illuminator (e.g. an arc lamp) through a spinning color wheel having transmissive color segments, or by using a set of solid-state illuminators, such as lasers and light-emissive-diodes (LEDs). Due to the large volume and short lifetime compared to solid-state illuminators, traditional illuminators are not suitable for compact or portable display systems. Even though solid-state illuminators have been growingly used in display system due to their compact sizes and longer lifetimes, some solid-state illuminators, such as lasers, are preferably operated at continuous mode (at ON all the time during operations) to obtain optimal performances (e.g. maximum output power), the continuous mode of which is not often allowed in existing display systems.

### SUMMARY

In one example, a method of displaying an image is disclosed herein. The method comprises: providing a light valve comprising an array of light valve pixels; configuring the light valve pixels such that each light valve pixel represents a discrete grayscale level; and imaging the light valve pixels on a screen such that a screen pixel has a perceived grayscale level that is an addition of grayscales represented by a plurality of light valve pixels.

In another example, a video displaying system is provided herein. The system comprises: a light source providing light; a light valve comprising an array of individually addressable pixels; a scanning mechanism disposed for causing the light from the light valve pixels to scan a screen; an image processing unit connected to a video source containing a video stream such that the video stream can be displayed on the screen.

In yet another example, a method of producing an image is provided herein. The method comprises: providing a light valve comprising first and second groups of individually addressable pixels; illuminating the light valve such that the light valve pixels of the first and second groups receive light of different colors; causing the light from the light valve pixels in the first and second groups to illuminate a first row of image pixels on a screen such that the image pixels in said first row has a first illumination color and intensity distribution across the image pixels in said first row; and moving the light from the first and second light valve pixel rows onto a second image pixel row such that the image pixels in said second row has a second illumination color and intensity distribution across the image pixels in said second row.

In still yet another example, a method of producing a color image is disclosed herein. The method comprises: illuminating an array of individually addressable pixels of a light valve by an illumination light that comprises red, green, and blue colored light components; and directing the red, green, and blue light components onto a movable reflective mirror so as to scan the screen with the red, green, and blue light components, wherein a group of light valve pixels illuminated by one of said red, green, and blue colored light is spatially combined to illuminate single image pixel.

### BRIEF DESCRIPTION OF DRAWINGS

FIG. 1 schematically illustrates an exemplary imaging system in which examples of this disclosure can be implemented;

FIG. 2 schematically illustrates an exemplary illumination system of the display system in FIG. 1;

FIG. 3 schematically illustrates a top view of a light valve in FIG. 1;

FIG. 4 schematically illustrates an exemplary micromirror device of a micromirror device array in a light valve that can be used for the display system in FIG. 1;

FIG. 5 schematically illustrates an exemplary array of micromirror devices of the light valve illustrated in FIG. 3;

FIG. 6 schematically illustrates another exemplary array of micromirror devices of the light valve illustrated in FIG. 3;

FIG. 7 schematically illustrates another exemplary imaging system in which examples of this disclosure can be implemented;

FIG. 8 schematically illustrates yet another exemplary imaging system in which examples of this disclosure can be implemented;

FIG. 9 through FIG. 1 schematically demonstrate an exemplary method of producing grayscale images using a imaging system;

FIG. 12 and FIG. 13 schematically demonstrate an exemplary method of producing color images using a imaging system;

FIG. 14 schematically demonstrates another exemplary method of producing color images using a imaging system;

FIG. 15 schematically demonstrates yet another exemplary method of producing color images using a imaging system;

FIG. 16 schematically demonstrates another method of producing grayscale images; and

FIG. 17 schematically demonstrates another method of producing color images.

### DETAILED DESCRIPTION OF SELECTED EXAMPLES

An imaging system comprising a light valve and a method of processing images using the imaging system are disclosed herein. The image processing can be an image producing (e.g. image displaying) process, an image information storing process (e.g. writing image information on a storage media or a printing process), or any other suitable image processes.

The light valve of the imaging system can be a reflective, transmissive, or self-light emissive light valves, each light valve of which comprises an array of individually addressable pixels. It is preferred that the light valve is a non-diffractive light valve, though not required. Examples of light valves include, but are not limited to, spatial light modulators (e.g. micromirror-based spatial light modulators, liquid-crystal display panels (LCD), liquid-crystal-on-silicon (LCOS) based spatial light modulators, silicon crystal reflective display panels (sXRD), interferometric modulators, organic light-emitting diode displays, and plasma panels. It is noted that the pixels of the light valve each can be operated at a binary mode or an analog mode. At the binary mode, each pixel is operated at ON and OFF states that result in different brightness on a target, such as a screen of an image display system or a photosensitive material in a printing system. At an analog mode, each pixel is operated at multiple continuous or discrete states resulting in different brightness levels on the target. It is further noted that light valve pixels with analog operation ability can also be operated at a binary mode.

The light valve comprises n rows and m columns; and the processed images on the target each have p rows and q columns, wherein n, m, p, and q are integers. The ratio of n to m can be ½ or less, ⅓ or less, ¼ or less, ⅕ or less, or ⅙ or less; while the ratio of q to p is substantially 4:3, 16:9, 16:10, or any standard formats in image display applications. The ratio of n to p (and/or the ratio of m to q) can be ½ or less, ⅓ or less, ¼ or less, ⅕ or less, or ⅙ or less.

For generating grayscale/color images on the target, each light valve pixel represents a grayscale level. This can be accomplished by pre-determining an intensity distribution across the light valve pixel array; sampling the intensity distribution by discrete intensity levels; and accomplishing each discrete intensity level by one or a group of light valve pixels at the ON state (when the light valve pixels are operated at a binary mode) or a state wherein the light from the light valve pixels is expected to be on the target (when the pixels are operated at an analog mode). As a result, when a light valve pixel representing a specific grayscale is imaged onto the target, the resulted target pixel will have a perceived intensity that is represented by the light valve pixel. The desired grayscale of a specific target pixel can then be accomplished by setting the light valve pixels representing different grayscale levels to different operational states, and imaging the light valve pixels in a way such that the light from the light valve pixels can be overlapped on the specific target pixel. The perceived overall grayscale of the specific target pixel is the sum of the grayscales represented by light valve pixels whose light arrives at the specific target pixel. The desired color of a specific target pixel can be accomplished in the same way by adding light valve pixels of different grayscales and different colors at the target pixel.

In the following, the method and the system will be discussed with selected examples wherein the imaging systems are image display system (hereafter, display system), such as rear- and front projectors. It will be appreciated by those skilled in the art that the following discussion is for demonstration purpose, and should not be interpreted as a limitation. Instead, many other variations within the scope of this disclosure are also applicable.

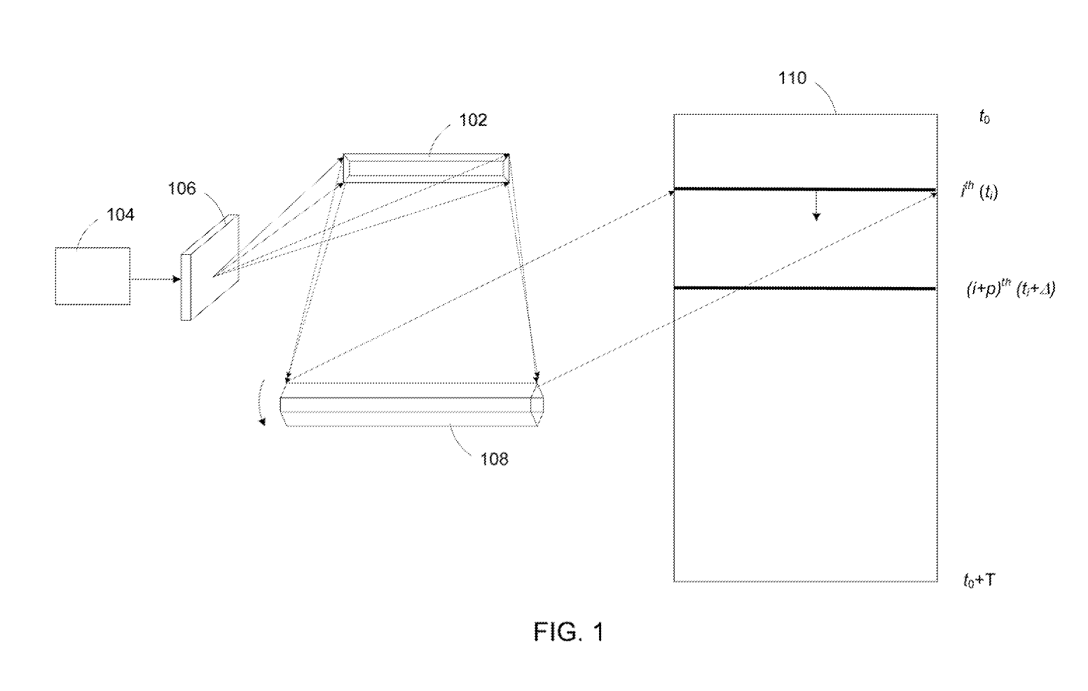

Referring to the drawings, FIG. 1 schematically illustrates an exemplary display system. The display system comprises illumination system 104, optical element 106, light valve 102, and optical element 108. Screen 110 may or may not be a component of the display system.

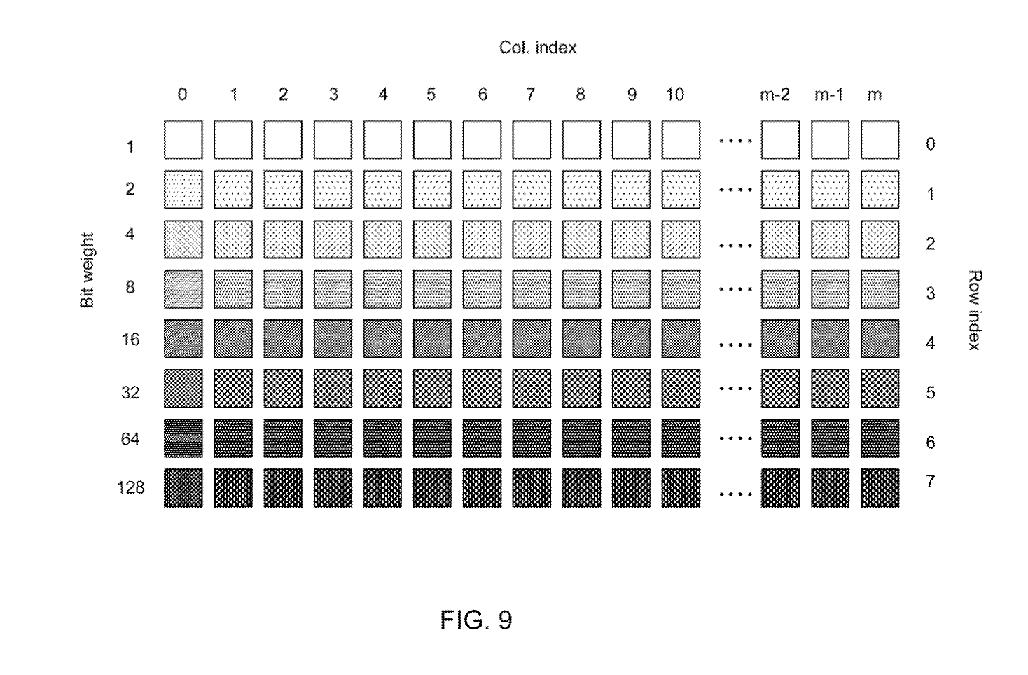

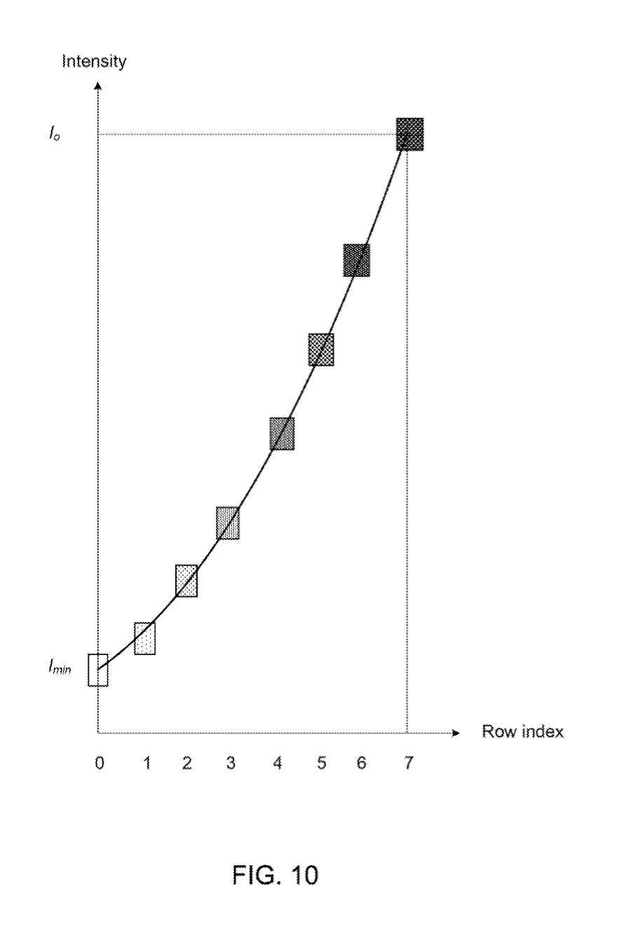

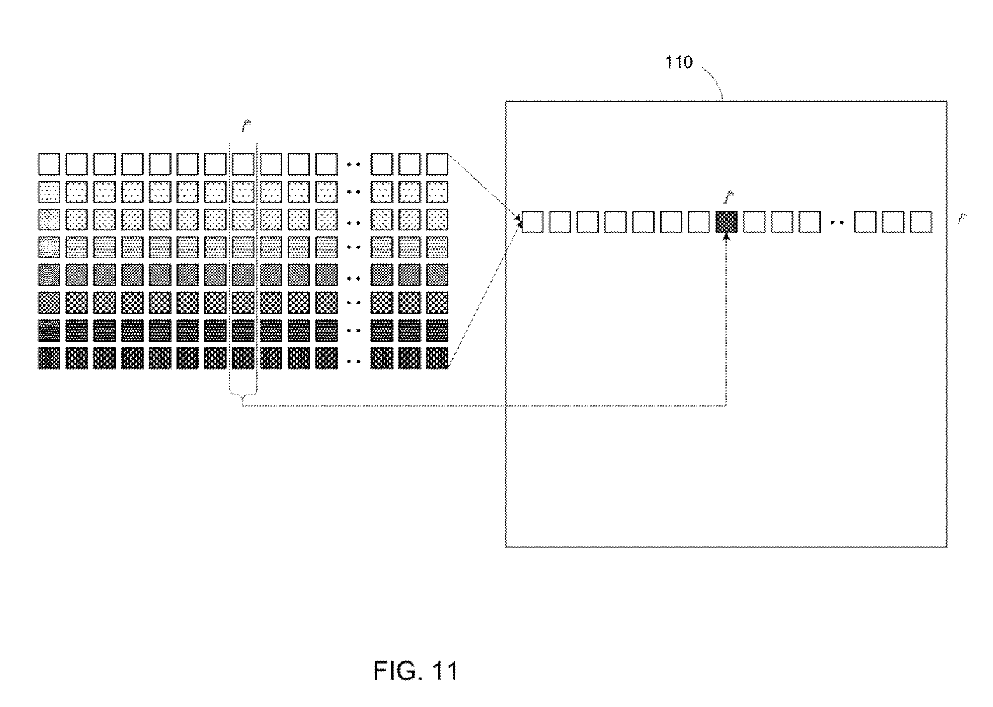

The illumination system (104) provides illumination light. The illumination light is directed to light valve 102 by optical element 106. To display grayscale/color images on screen 110, each light valve pixel can be assigned to represent a discrete grayscale level. An approach for enabling such representation is to illuminate the light valve pixels by a pre-determined illumination pattern with a selected non-uniform intensity distribution across the light valve pixel array. The light valve pixels sample the intensity distribution into discrete values (grayscale levels) such that the light from a light valve pixel has an intensity corresponding to a discrete grayscale level, which will be discussed afterwards with reference to FIG. 9.

The pre-determined illumination pattern on the light valve pixels can be generated by optical element 106, which can be an optical diffuser, such as an engineered bulk- or surface optical diffuser. The optical element (106) can be other suitable optical elements, such as diffractive optical elements with a diffractive pattern (e.g. a holographic optical element).

The light from the light valve is directed to optical element 108; and optical element 108 directs the incident light onto screen 110. To accomplish grayscale levels on the screen using the discrete grayscale levels represented by the light valve pixels, an approach is to converge light from the light valve pixels onto single row of screen pixels at each time; and scanning the screen by converging the light from the light valve pixels sequentially onto consecutive screen rows. This process is repeated until all rows of screen pixels are scanned at least once.

In one example as illustrated in FIG. 1, the light valve pixels are imaged onto the i^{th} row of screen pixels at time tᵢ, wherein the i^{th} row of screen pixels has substantially the same number of pixels as the light valve pixels in each row. Light from light valve pixels at the ON-state (or a state wherein the light is desired to be on the screen) are converged to the i^{th} row of screen pixels. After the convergence, the light from the light valve pixels in one column are overlapped at a screen pixel of the i^{th} row. Specifically, light valve pixels of the same column are imaged onto substantially the same screen pixel at a time such that the intensity (grayscale) of the screen pixel is an addition of the grayscales represented by the light valve pixels in the column. At time tᵢ+Δ, light valve pixels are imaged to the (i+p)^{th} row on the screen. The process continues until all screen rows are scanned for at least one time.

The above light-valve pixel imaging process can be performed along any desired directions, such as along the vertical direction (e.g. from the top to the bottom row of the screen or reverse), the horizontal direction (e.g. from the left to the right row of the screen or reverse), or any other desired directions, such as along the diagonal of the screen.

The full-scan time, during which all screen pixels are scanned at least once, corresponds to a frame time of the image to be displayed. The light valve pixels maintain their individual operational states during the converging for each screen row; and can be updated after each convergence. In one example wherein a light valve having 1920 columns and 200 or less rows is used to display an image with a resolution of 1920 columns and 1080 rows), the light valve pixels can be updated around every 15 micro-seconds in an image frame.

It is noted that FIG. 1 schematically illustrates converging light from light valve pixels onto single row of the screen pixels. This is only one of many possible ways of displaying grayscale/color images. In other examples as will be detailed in the following examples, the light from the light valve pixels can be converged to a block of rows of screen pixels.

The light from the light valve pixels can be projected and converged onto the row(s) of the screen pixels in many ways. In one example, a rotating polygonal mirror (108) with multiple reflective facets can be employed as illustrated in FIG. 1. The polygonal mirror may have any suitable number of reflective facets, such as 3 or more, 10 or more, 20 or more, 30 or more, or 40 or more, or any desired number of facets. The polygonal mirror may have any suitable radius, which is defined as the radius of the circumcircle of the polygon. As an example, the radius can be from 5 to 500 mm, or any suitable values. It is noted that the number of facets and the radius of a regular polygon determine the sizes (e.g. widths) of the polygon facets; and the size of the facet determines the duty cycle of the facet for a given illuminator. Specifically, the duty cycle can be defined as (1−d/D), wherein d is the dimension (e.g. the diameter) of the illumination area on the facet caused by the incident illumination light beam; and D is the characteristic dimension (e.g. the width) of the facet. When the duty cycle is large (d is large), the blank time is large, wherein a blank time is a time period during which the top and the bottom portions of the screen are illuminated while the middle portion is not. This arises from the fact that when d is large, an edge of two adjacent facets takes a longer time to transit from one facet to another. This black time period is often not usable in displaying images, which reduces optical efficiency of the display system. Therefore, it is desired (thought not required) to have a duty cycle of 75% or more, 85% or more, 90% or more, or 95% or more. Of course, the duty cycle may have other values in some examples. During operation, the light from the light valve pixels is directed to a reflective facet. As the polygonal mirror rotates, each reflective facet changes its angle relative to the incident direction of the light from the light valve pixels; and the light from the light valve pixels scans each reflective facet from one edge to the other along the direction perpendicular to the rotation axis of the polygonal mirror. During the period wherein the light from the light valve pixels scans each reflective facet from one edge to the other, the converged light scans substantially all screen pixels for least one time.

Other than a polygonal mirror, other means for projecting and converging light from the light valve pixels are also applicable. For example, a vibrating/oscillating reflective mirror that moves within a range can be employed, wherein the moving range corresponds to the scan distance that the converged light scans the screen pixels, such as the vertical distance, the horizontal distance, or the diagonal distance of the screen pixel array on the screen. Optical element 108 can be replaced by a transmissive optical element with the capability of projecting and converging light from the light valve pixels onto the screen pixels. For example, optical element 108 can be replaced by a transmissive optical element having a refractive pattern. The refractive pattern selectively changes the propagation path of incident light having different incident light angles so as to accomplish the convergence and projection.

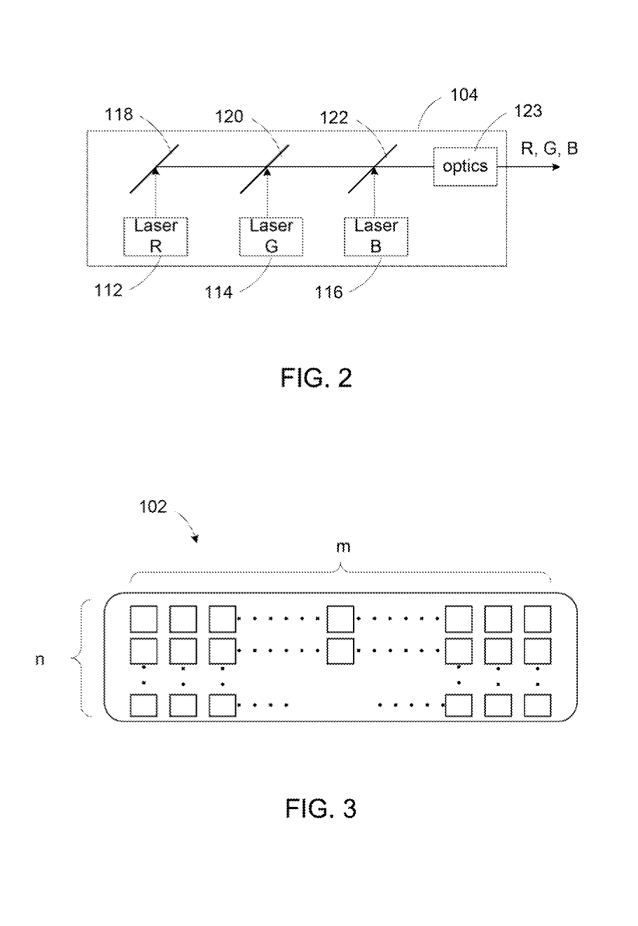

The illumination system (104) provides illumination light for illuminating the light valve pixels. The illumination system may use any desired illuminators, such as arc lamps, solid-state illuminators (e.g. lasers and light-emissive-diodes), and other narrow-banded illuminators. When an illuminator emitting white light, such as an arc lamp, is employed, a color filter, such as a stationary color filter may be used for generating a set of colors, such as colors selected from red, green, blue, yellow, cyan, magenta, and white. The generated colors of light are directed to the light valve pixels for displaying color images. FIG. 2 schematically illustrates another exemplary illumination system that employs solid-state illuminators, such as lasers.

Referring to FIG. 2, illumination system 104 comprises laser R 112, laser G 114, and laser B 116 respectively for providing red, green, and blue colors of laser beams for the display system. The red, green, and blue laser beams are directed to light valve along different optical paths, or along the same optical path as shown in FIG. 2. Specifically, red filter 118 capable of reflecting red color laser beams is disposed such that the reflected red laser beams from laser R 112 propagate towards green filter 120 and blue filter 122. Green filter 120 passes the red laser beams from red filter 118 and reflects the green laser beams from laser G 114 toward blue filter 122. Blue filter 122 passes red and green laser beams incident thereto and reflects the blue laser beam from laser B 116. As such, the red, green, and blue laser beams can be combined together.

Other optical components 123, such as diffusers, lenses, prisms, light integrators, and any suitable holographic optical elements with diffractive patterns can alternatively be included in illumination system 104 when necessary. For example, one or more beam deflectors with diffractive patterns can be provided for guiding the light beams from the illuminators towards the light valve along desired directions. In another example, one or more diffractive beam-splitters or beam-dispersers can be provided for guiding different portions (e.g. portions of different characteristic wavelengths) of the light from the illuminators towards the light valve assemblies (or different light valves when employed in one display system) along different optical paths.

The light valve in the display system in FIG. 1 is a reflective or transmissive spatial light modulator comprising n rows and m columns of individually addressable light valve pixels, as schematically illustrated in FIG. 3 wherein each square represents a light valve pixel. The image produced on the screen has p rows and q columns of screen pixels, wherein n, m, p, and q are integers. In one example, the ratio of n to m can be ½ or less, ⅓ or less, ¼ or less, ⅕ or less, or ⅙ or less; while the ratio of q to p is substantially 4:3, 16:9, 16:10, or any standard formats in image display applications. The ratio of n to p (and/or the ratio of m to q) can be ½ or less, ⅓ or less, ¼ or less, ⅕ or less, or ⅙ or less. For example, the light valve may comprise 640 or higher columns and 100 or less rows, 800 or higher columns and 120 or less rows, 1024 or higher columns and 140 or less rows, 1280 or higher columns and 200 or less rows, 1280 or higher columns and 200 or less rows, 1400 or higher columns and 200 or less rows, 1600 or higher columns and 200 or less rows, or 1920 or higher columns and 200 or less rows. Other values of numbers of columns and rows of the light valve are also applicable. For example, the light valve may have 20 or less rows, such as 10 or less number of rows. Less number of rows of course benefits cost-efficiency of the light valve.

It is noted that FIG. 3 schematically illustrates that the number of columns is more than the number of rows in the light valve. This is only one of many possible examples. In other examples, the number of rows may be more than the number of columns depending upon the scanning direction on the screen. For example, if the scanning is to be performed horizontally (e.g. from the left to the right of the screen), the number of rows of the light valve may be substantially the same as the number of rows of the desired image on the screen; while the number of columns can be less than the number of columns of the desired image to be produced on the screen.

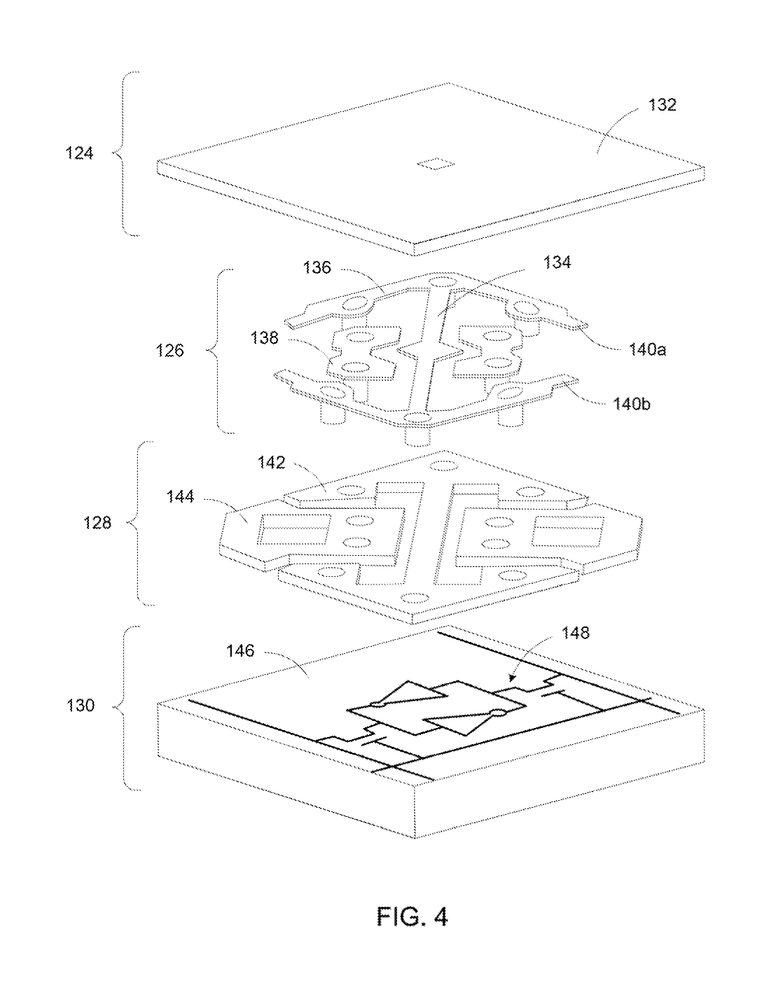

As discussed before, the pixels of the light valve in the display system illustrated in FIG. 1 can be any suitable reflective or transmissive pixels. In one example, the pixels of the light valve are reflective and deflectable micromirror devices, one of which is schematically illustrated in FIG. 4.

Referring to FIG. 4, the micromirror device comprises substrate layer 130 in which substrate 146 is provided. Substrate 146 can be any suitable substrates, such as semiconductor substrates, on which electronic circuits (e.g. circuits 148) can be formed for controlling the state of the micromirror device.

Formed on substrate layer 128 is electrode pad layer 128 that comprises electrode pad 144 and other features, such as electronic connection pad 142 that electrically connects the underlying electronic circuits to the above deformable hinge and mirror plate. Hinge layer 126 is formed on the electrode pad layer (128). The hinge layer comprises deformable hinge 134 (e.g. a torsion hinge) held by hinge arm 136 that is supported above the substrate by hinge arm posts. Raised addressing electrodes, such as electrode 138 is formed in the hinge layer (126) for electrostatically deflecting the above mirror plate. Other features, such as stopper 140a and 140b each being a spring tip, can be formed in the hinge layer (126). Mirror plate layer 124, which comprises reflective mirror plate 132 attached to the deformable hinge by a mirror post, is formed on the hinge layer (126).

FIG. 4 schematically illustrates one of many possible micromirror devices. In other examples, the micromirror device may comprise a light transmissive substrate, such as glass, quartz, and sapphire, and a semiconductor substrate formed thereon an electronic circuit. The light transmissive substrate and the semiconductor substrate are disposed approximate to each other leaving a vertical gap therebetween. A reflective mirror plate is formed and disposed within the gap between the light transmissive and semiconductor substrates. In another example, the reflective mirror plate can be in the same plane of the light transmissive substrate and derived from the light transmissive substrate.

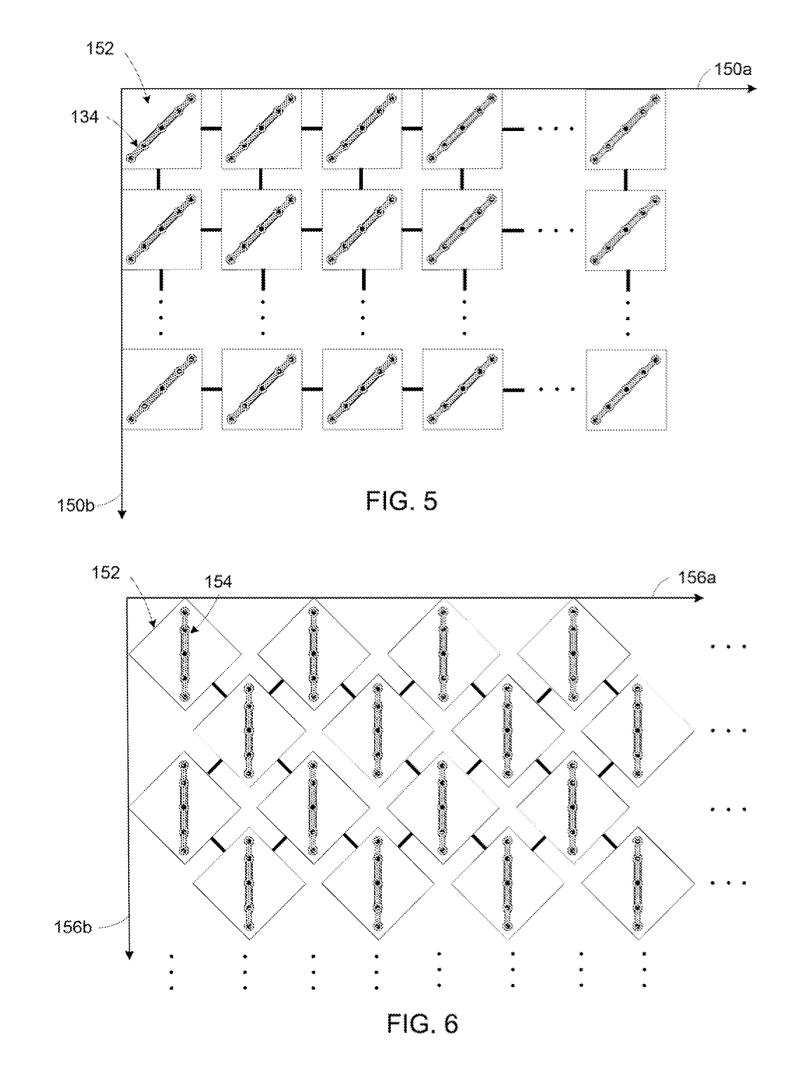

The micromirror devices, such as that discussed above with reference to FIG. 4, can be arranged in the light valve in many desired ways, an example of which is schematically illustrated in FIG. 5.

Referring to FIG. 5, the micromirror devices are arranged such that each micromirror device takes a substantially square shape (or a rectangular shape); and the micromirror devices in the array are interconnected. The major edges of the micromirror device are substantially parallel to the edges of the micromirror array. The edges of the micromirror array are straight lines with each having a length equal to or longer than the largest dimension of a micromirror device in the array. The straight lines together form a closed region with the least area in which all micromirror devices are enclosed. For example, lines 150a and 150b are two major edges of the micromirror array. Each micromirror device is disposed in the array such that the major edges of the micromirror device are parallel to the major edges of the micromirror array. The deformable hinge (e.g. deformable hinge 134 of micromirror device 152) in each micromirror device, however, forms an angle, such as from 20° to 60° degrees relative to the edges of the micromirror array. The activation and reading/writing lines (e.g. wordlines and bitlines) for activating and setting the operation status of the individual micromirror devices can also be parallel to the edges of the micromirror array.

In an alternative configuration, each micromirror can be rotated by an angle so as to form a diamond lattice, as schematically illustrated in FIG. 6. Referring to FIG. 6, straight lines 156a and 156b are two major micromirror array edges. Each micromirror device in the array, such as micromirror device 152, is rotated along its center in the plane of the micromirror array a specific angle, such as from 10° to 80° degrees, from 20° to 70° degrees, and more preferably around 45° degrees. Adjacent micromirror devices in each row of the micromirror array are connected through a micromirror device in the immediate next row, as illustrated in the figure. Such configuration has many benefits, such as larger filling rate. Due to the rotated micromirror devices, the deformable hinge of each micromirror device can be parallel to a major edge of the micromirror array, such as deformable hinge 154 being parallel to edge 156b.

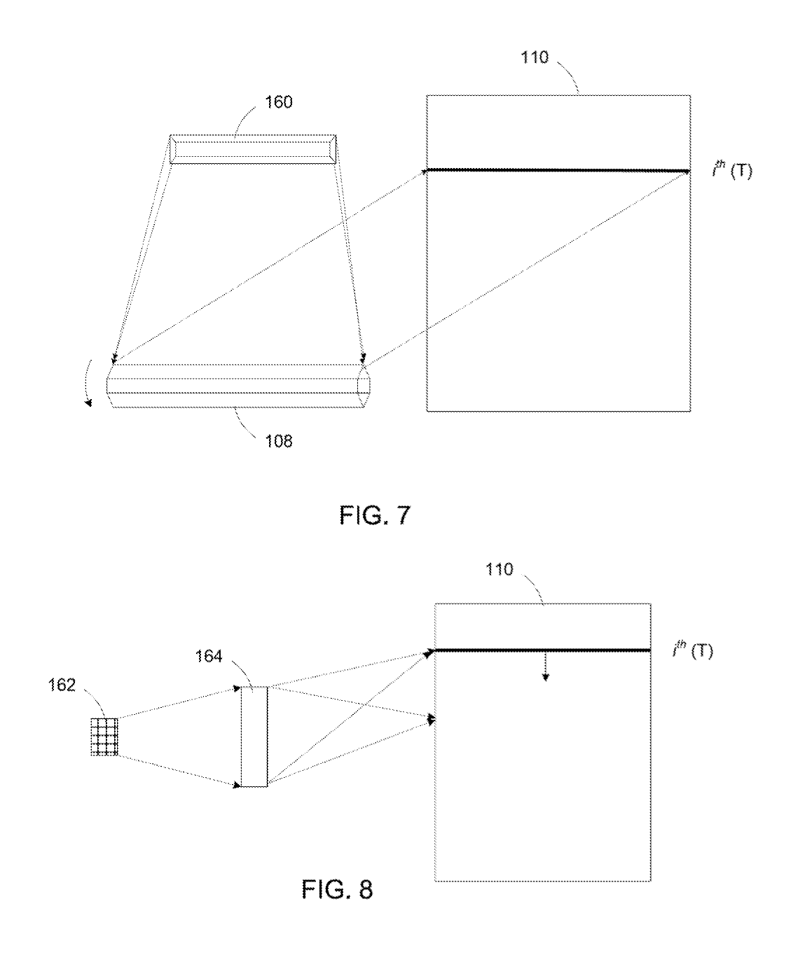

The display system as discussed above employs a spatial light modulator that is a non-self-light emitting light valve; and illumination system 104 and optical element 106 are provided for generating illumination light and directing the illumination light onto the light valve (102). In an alternative example as illustrated in FIG. 7, the light valve of a display system can be a self-light emitting light valve, such as plasma, organic light-emitting diode displays, and other types of devices. In this example, an illumination system as that in FIG. 1 may not be necessary.

Referring to FIG. 7, self-light emitting light valve 160 is provided. Because light valve 160 is capable of emitting light, external illumination systems, such as that in FIG. 1, as well as optical element for directing light onto the light valve, may not be necessary.

The light from light valve 160 is directed to optical element 108, which can be a polygonal mirror or any other suitable optical elements. Optical element 108 converges the incident light onto one or a block of screen pixels on screen 110. For example, the light from light valve pixels can be converged onto the i^{th} row of the screen pixel array. By such converging, light valve pixels in each column are overlapped at a screen pixel of the i^{th} row on the screen. The converging process is repeated until substantially all screen pixels are scanned at least once. The scan can be performed along any desired directions on the screen as discussed above with reference to FIG. 1, which will not be repeated herein.

It is noted that because the light valve is a self-light emitting light valve, the illumination pattern (intensity distribution) for displaying grayscale/color images on the screen can be actively generated by the pixels of the light valve. Specifically, when the light valve pixels are operated at analog mode comprising a number of operational states, an intensity distribution can be obtained by setting the light valve pixels at different locations to different analog states based on the desired intensity distribution. In other words, a desired intensity distribution can be simulated by the distribution of different operational states of the light valve pixels. When the light valve pixels are operated at binary modes, an intensity distribution can be obtained by turning the light valve pixels at different locations corresponding to the intensity distribution to the ON/OFF states for different time periods.

For displaying gray/color images, each light valve pixel represents a discrete grayscale level. Specifically, light from each light valve pixel has different intensity levels; and each intensity level corresponds to a grayscale level. A desired grayscale/color image can be produced by deriving a set of bitplanes each corresponding to a discrete grayscale level; and displaying the bitplanes by the light valve pixels. With this color presentation scheme, higher bit depth per color (i.e. the total numbers of bits representing gray levels of a specific color) can be obtained as compared to existing display system using a traditional pulse-width-modulation technique wherein all light valve pixels are updated by a bitplane at a time. This arises from the fact that the bit depth per color in the color presentation scheme of this disclosure is determined by the number of rows (or columns) of the light valve used for representing a particular color.

In one example wherein a pulse-width-modulation (PWM) technique is employed, each light valve pixel represents a bit of a particular PWM scheme, such as a binary PWM scheme, a uniform PWM scheme, a random PWM scheme, or any other suitable PWM schemes. In the following, methods of displaying grayscale/color images will be discussed with reference to examples wherein a binary PWM algorithm is employed. However, it will be appreciated by those skilled in the art that the following discussion is for demonstration purpose and should not be interpreted as a limitation. Other variations within the scope of this disclosure are also applicable.

Referring to FIG. 9, a method of displaying grayscale and monochromatic images is demonstrated. Squares in FIG. 9 represent the pixels of the light valve. Squares with the same filling pattern represent the light valve pixels having substantially the same intensity of the light exiting from the pixels (the same grayscale level or the same binary PWM bit); while squares with different filling patterns represent light valve pixels having different intensities (different grayscale levels or different binary bits). Assuming 8 bits are assigned to produce the grayscale, eight rows consecutively indexed from 0 through 7 are used to represent bits from 1 (least-significant-bit) through 128 (most-significant-bit), as illustrated in FIG. 9. Each row has m light valve pixels; and the m light valve pixels in each row represent the same bit. This intensity distribution (or bit-representation scheme) corresponds to the scanning scheme wherein the screen images are scanned vertically such as that illustrated in FIG. 1. Accordingly, the number of columns, m, is substantially the same as the image pixels of the produced image on the screen.

To accomplishing representation of different grayscale levels (PWM bits), an illumination pattern with a specific intensity distribution across the light valve pixel array is predetermined; and the light valve pixels sample the intensity distribution into discrete values (grayscale levels) such that the light from a light valve pixel has an intensity corresponding to a discrete grayscale level, as schematically illustrated in FIG. 10.

Referring to FIG. 10, the continuous curve represents a particular intensity distribution across the light valve pixel array. The particular intensity distribution curve can be any suitable shape, such as exponential, Gaussian, triangle, linear, and uniform. It is noted that the continuous curve can be replaced by other pre-determined number sets, such as discrete data sets. As an example, a pre-defined intensity distribution can be a Fibonacci serial with n orders corresponding to the most significant bit; and each number in the Fibonacci serial corresponding to a bit. The following discussion assumes the pre-defined intensity distribution is a continuous curve. However, it will be appreciated by those skilled in the art that the following discussion is for demonstration purpose, and should not be interpreted as a limitation. The method to be disclosed hereafter is also applicable to other possible pre-determined intensity distributions including but not limited to discrete distributions. The continuous distribution curve is sampled by discrete grayscale levels, each of which is represented by a row of light valve pixels. When the intensity pattern is generated by illuminating the light valve pixels with an illumination system as illustrated in FIG. 1, each light valve pixel may have an intensity distribution across the light valve pixel. In this instance, the discrete grayscale level represented by the light valve pixel can be determined as the average or the maximum (or minimum) or other values of the intensity across the light valve pixel.

In the example as illustrated in FIG. 10, the seventh row represents the maximum intensity Iₒ corresponding to the MSB with the bit weight of 128; the sixth row represents the intensity of Iₒ/2 corresponding to the bit with the bit weight of 64; the fifth row represents the intensity of Iₒ/2² corresponding to the bit with the bit weight 32; the fourth row represents the intensity of Iₒ/2³ corresponding to the bit with the bit weight 16; the third row represents the intensity of Iₒ/2⁴ corresponding to the bit with the bit weight 8; the second row represents the intensity of Iₒ/2⁵ corresponding to the bit with the bit weight 4; the first row represents the intensity of Iₒ/2⁶ corresponding to the bit with the bit weight 2; and the oth row represents the intensity of Iₒ/2⁷ corresponding to the bit with a bit weight of 1.

It is noted that the intensity distribution representation by light valve pixels illustrated in FIG. 9 is only one of many possible examples. Other variations are also applicable. For example, light valve pixel rows representing different bits can be arranged in the light valve pixel array in any desired ways, especially when the light valve pixels are self-light emitting pixels. The rows of light valve pixels can be arranged in ascending or descending orders of bit weights or can be in any other orders, such as a random order.

The light from the light valve pixels can be converged to substantially a single row on the screen at a time, as illustrated in FIG. 11. Referring to FIG. 11, light from the light valve pixels representing the same bits are projected onto different screen pixels; while light from the light valve pixels representing different bits and positioned in the same column are converged to substantially one screen pixel at a time. For example, light from light valve pixels at the j^{th} column is converged to the corresponding j^{th} screen pixel of the i^{th} row on screen 110 at a time. Because different light valves at the j^{th} column represent different bits (grayscale levels), the effective grayscale level (perceived by viewers) of the j^{th} screen pixel at the i^{th} row is the sum of all grayscale levels represented by the light valve pixels at the j^{th} column. By turning the light valve pixels of the j^{th} column to or away from their designated operational states (e.g. ON and OFF state in a binary mode, or designated operational states in an analog mode), the effective grayscale level of the j^{th} screen pixel at the i^{th} row can be changed to the desired value.

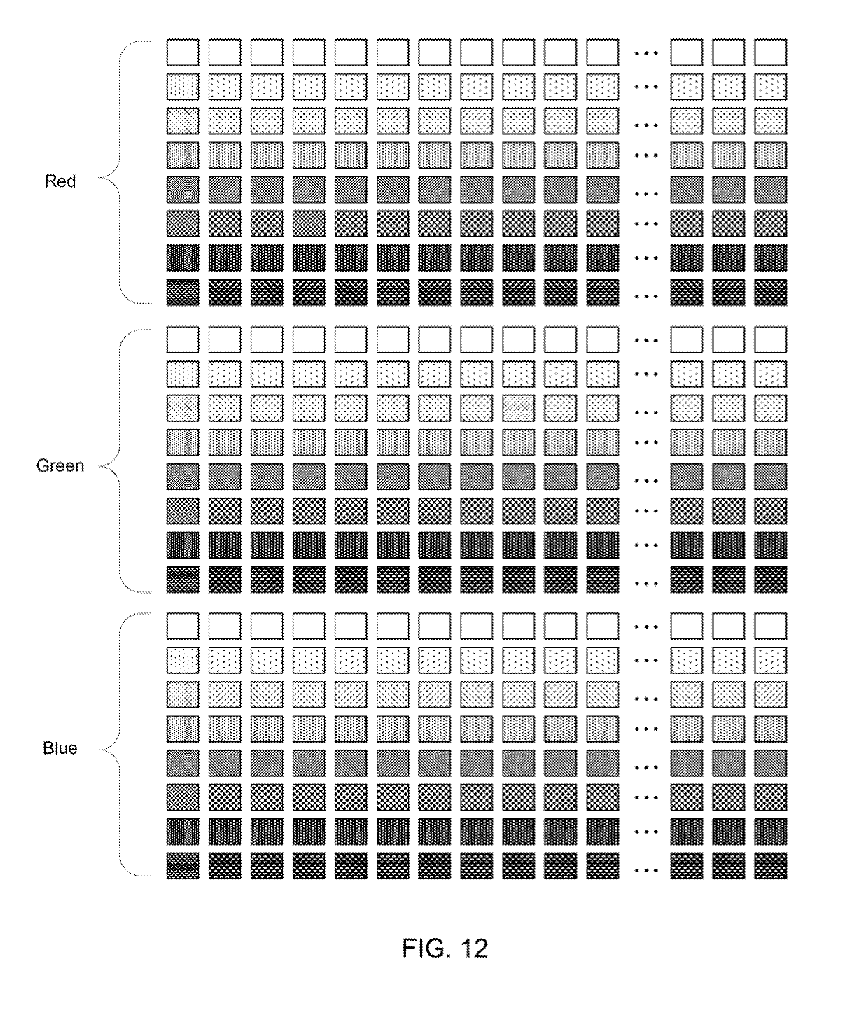

After the above converging (projecting) process, the light valve pixels are updated based the image data corresponding to the next screen row, such as the (i+1)^{th} screen row. The light from the updated light valve pixels are converged to the (i+1)^{th} screen row. The above scanning/projecting process continues until all image rows on screen 110 are scanned at least once, thereby, producing the desired grayscale image on the screen. The above grayscale image displaying method can be expanded to display color images, as demonstrated in FIG. 12.

Referring to FIG. 12, the rows of the entire light valve pixel array can be divided into a number of row blocks with each row block corresponding to one of a set of colors selected for displaying color images. In one example, the rows of the light valve pixel array are divided into three row blocks for red, green, and blue colors. Each row block can be configured in the same way as that discussed above with reference to FIG. 10 for displaying a monochromatic image. Specifically, an intensity distribution of each color light is created at each light valve pixel block; and the intensity distributions of different colors at different pixel blocks may or may not be the same. Light from the color pixel blocks can be converged to substantially single row of the screen, as illustrated in FIG. 13. It is noted that blank rows of light valve pixels can be disposed between adjacent color blocks, though it is not required.

Referring to FIG. 13, light from the light valve pixels of all color blocks can be converged to a row, such as the i^{th} row of screen 110. Light from the light valve pixels in color pixel blocks with the same column index, such as j^{th} column, are converged to a screen pixel at the j^{th} column and the i^{th} row. As a result, different colors (red, green, and blue) with different bits (grayscale levels) are summed so as to obtain the desired color and intensity for the screen pixel at the j^{th} column and the i^{th} row. The same is applied to all other screen pixels at the i^{th} row. After creating the desired colors and intensities for the pixels at the i^{th} row, the light valve pixels can be updated; and the above converging process is repeated for the screen pixels at the next row, such as the (i+1)^{th} row. The above process is repeated until all screen pixels are scanned at least once.

It is noted that when the light valve pixels are self-light emitting pixels, rows of light valve pixels in different colors can be in different pixel blocks as illustrated in FIG. 13. Alternatively, rows of different colors may not be grouped in pixel blocks. Instead, the light valve pixel rows of different colors can be arranged in the light valve in any desired orders. For example, rows of light valve pixels having the same bits and different colors can be adjacent in the light valve. The arrangement of the rows of pixels in each color block can be independent. Specifically, rows of pixels in one color block can be arranged in ascending order, descending order, or any desired orders without concerning of the arrangements of pixel rows in other color blocks.

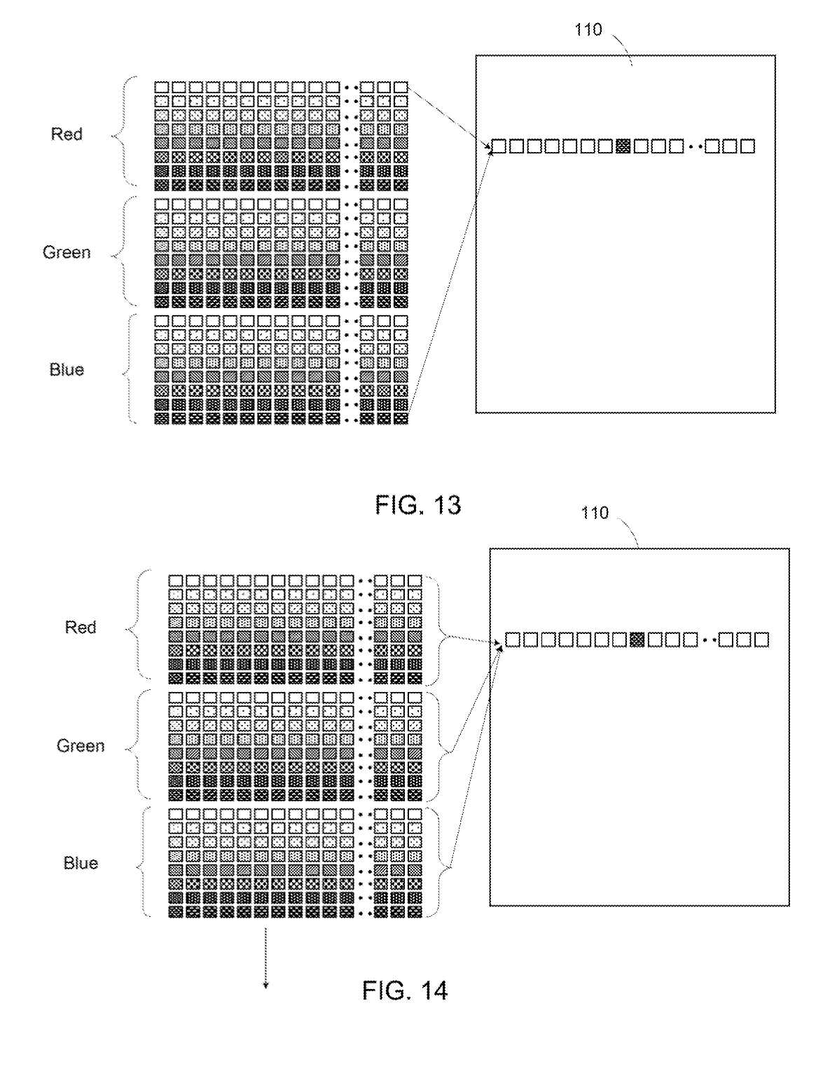

Other than converging light from all light valve pixels (all color blocks) onto substantially single screen pixel row on the screen, the converging can be performed on a color block basis at a time, as schematically illustrated in FIG. 14. Referring to FIG. 14, at each converging time, light from pixels in each color block, such as the red color block, is converged onto single row on the screen, such as the i^{th} row. After such convergence, screen pixels of the single screen row exhibit desired grayscale levels for the color of the color block. At another time before updating the pixels of the light valve (or before updating the light valve pixels that have not been mapped to the screen pixels), light from the light valve pixels of another color block, such as the green color block, is converged onto the same row (the i^{th} row). The above converging is repeated for all color blocks.

After converging light from the color blocks onto the single screen row, the light valve pixels can be updated. The converging can be performed for the next screen row, such as the (i+1)^{th} row on the screen. The above converging and pixel updating processes continue until all screen rows on the screen are scanned at least once.

In an example wherein light valve pixel rows having the same bits (bit weights) and different colors are adjacent and color blocks are not defined, the rows of the same bit of different colors can be formed as a sub-group. For example, a sub-group may comprise Rᵢ^{th}, G₍ᵢ₊₁₎^{th}, and B₍ᵢ₊₂₎^{th} light valve pixel rows, wherein Rᵢ^{th} light valve pixel row is the i^{th} light valve pixel row with the red color; wherein G₍ᵢ₊₁₎^{th} light valve pixel row is the (i+1)^{th} light valve pixel row with the green color; and wherein B₍ᵢ₊₂₎^{th} light valve pixel row is the (i+2)^{th} light valve pixel row with the blue color. Light valve pixels of the rows Rᵢ^{th}, G₍ᵢ₊₁₎^{th}, and B₍ᵢ₊₂₎^{th} have the same bit weight, such as 64. At a converging time, light from the sub-group having the Rᵢ^{th}, G₍ᵢ₊₁₎^{th}, and B₍ᵢ₊₂₎^{th} light valve pixel rows can be converged onto single screen row, such as the i^{th} screen row. With this convergence, pixels of the resulted screen row, the i^{th} screen row, exhibit the grayscale represented by the light valve pixels in the sub-group, such as 64.

At another time, light from another sub-group of light valve pixels with another bit weight is converged to the same screen row, the i^{th} screen row. The convergence process is repeated consecutively for all light valve sub-groups on the same screen row, the i^{th} screen row so as to produce the desired color and grayscale levels on the i^{th} screen row.

After mapping all light valve pixels (all sub-groups), the light valve pixels can be updated; and the convergence process is performed for the next screen row, such as the (i+1)^{th} screen row.

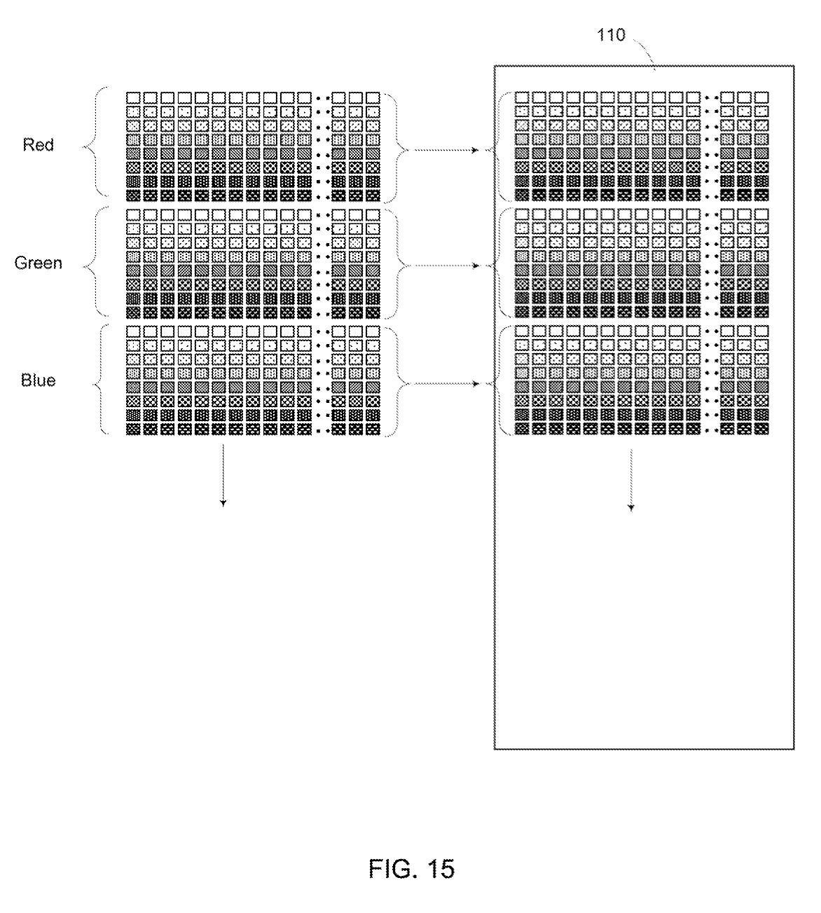

As another example, instead of converging light from the light valve rows onto single screen row, each light valve pixel can be projected (mapped) to a screen pixel on the screen for achieving grayscale levels and colors, an example of which is schematically illustrated in FIG. 15.

Referring to FIG. 15, each light valve pixel is imaged to an individual screen pixel at a time; and each color block of light valve pixels is imaged onto the screen (110) at a time. Images of the color blocks of light valve rows are then moved across the image area of the screen to sweep through all image rows in the image area. In the example as illustrated in FIG. 15, red, green, and blue color light-valve-pixel-blocks each are imaged on the screen, resulting in red, green, and blue color image-pixel-blocks at a time. The red, green, and blue color image-pixel-blocks can be moved by substantially one image-pixel-row down the screen at next time. As a consequence, the brightness of each image pixel row is determined by the sum of intensities represented by at least two light valve pixel rows. The above process is repeated until all image rows on the screen are illuminated. Update of light valve pixels can be managed in many ways. For example, light valve pixels can be updated once a stationary screen pixel row is canned by substantially all image rows in the moving image-pixel-blocks. In other words, an update can be triggered once the moving image-pixel-blocks move a distance on the screen substantially equal to the number of light valve rows. In the updating scheme, the stationary screen can be virtually divided into a set of screen-pixel-blocks with each screen-pixel-block substantially equal to the number of rows of light valve pixels. An update of light valve pixels occurs when an image of the light valve pixel array substantially falls in a screen-pixel-block, or when an image of the light valve pixel array is substantially not crossing the a boundary of adjacent screen-pixel-blocks.

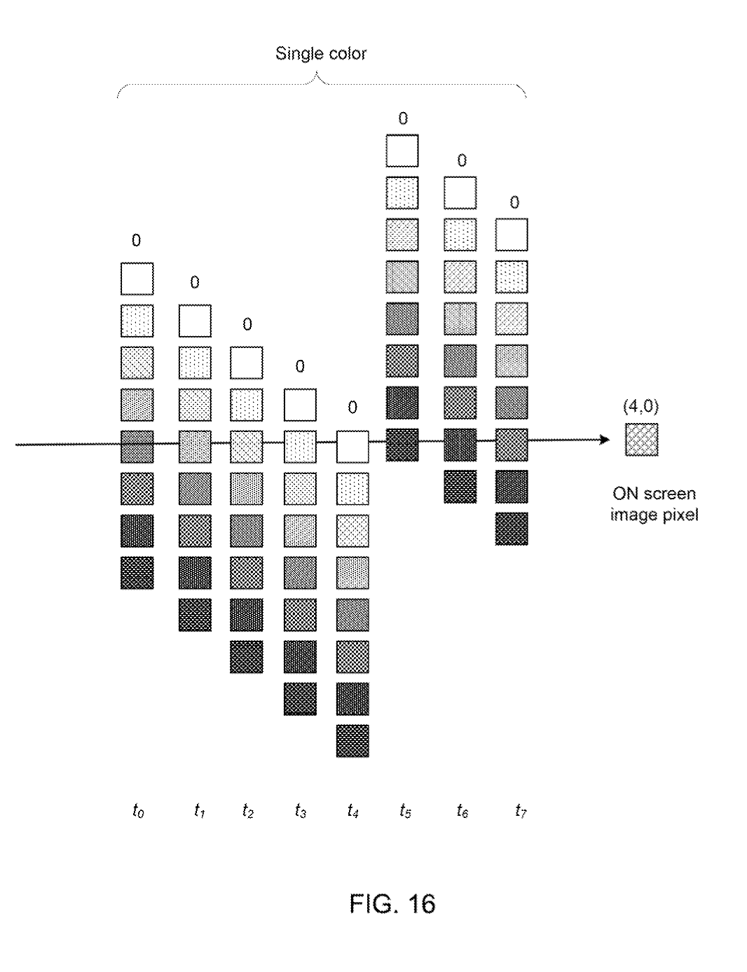

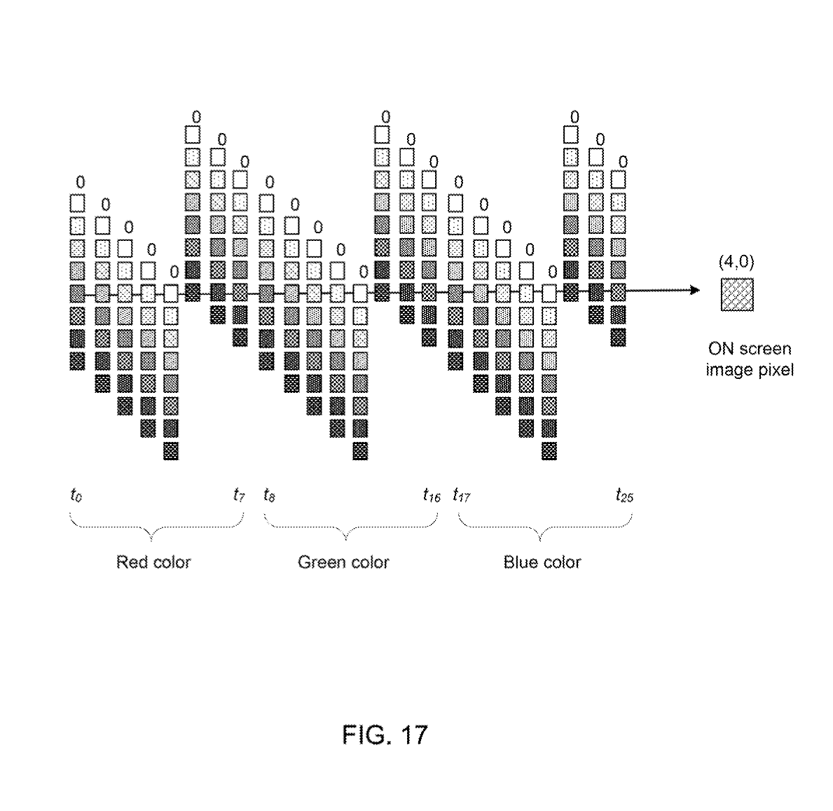

FIG. 16 schematically illustrates an exemplary way of generating a desired grayscale for single color on a screen pixel. Referring to FIG. 16, it is assumed that the screen pixel at the 4^{th} row and the 0^{th} column (4,0) is to be displayed. At time to, light valve pixels of the 0^{th} column are imaged on the screen at the first location, which causes the screen pixel (4, 0) having a grayscale represented by the (4, 0) light valve pixel. At time t₂, the light valve pixels are imaged at the second location on the screen, which is one row down from the first location on the screen. The light valve pixel (3, 0) is now imaged on to the screen pixel (4, 0). As a result, the grayscale represented by the light valve pixel (3, 0) is overlapped (added) to the grayscale level represented by (4, 0) light valve pixel at the screen pixel (4, 0). During the consecutive times t₂, t₃, t₄, t₅, t₆, and t₇, light valve pixels (2, 0), (1, 0), (0, 0), (7, 0), (6, 0), and (5, 0) are sequentially imaged onto screen pixel (4, 0). As a consequence, the grayscales represented by the light valve pixels in the 0^{th} column of the same color are overlapped at the screen pixel (4, 0)—resulting in the desired grayscale of the specific color. The above method of obtaining grayscale levels on the screen can be expanded to obtain the desired colors, which is schematically illustrated in FIG. 17.

Referring to FIG. 17, during the consecutive time periods from t₀ to t₇, from t₈ to t₁₆, and from t₁₇ to t₂₅, light valve pixels of the red, green, and blue color blocks (such as that illustrated in FIG. 12) are sequentially imaged onto the screen using the method as discussed above with reference to FIG. 16. Light valve pixels in the 0^{th} column of the color blocks are sequentially imaged at pixels of the 0^{th} screen column, such as screen pixel (4, 0). As such, desired colors and grayscale levels can be presented on the screen.

It is noted that FIG. 16 and FIG. 17 demonstrate only one of many possible examples. Other variations are also applicable. For example wherein the light valve pixels are self-light emitting pixels, rows of different colors can be arranged in the light valve in any desired orders as discussed above. When imaging the light valve pixels onto the screen, the light valve pixel rows of different colors can be imaged in any corresponding orders. As discussed above, the scan can be performed in any desired or suitable directions on the screen.

The method and imaging systems as discussed above, along with other variations within the scope, have many advantages over existing imaging systems. For example, the methods and imaging systems disclosed herein allow for a wider range of light valves in imaging systems as compared to existing systems and methods, such as compact, high yield, and/or low cost light valves. Due to the compact size of the light valve, other components, such as other image processing units (e.g. image data formatters) can be embedded on the light valve. The imaging systems, especially displaying systems, have greater motion rendition compared to existing display systems using light valves. Moreover, PWM artifacts, such as dynamic-false-contour artifacts, in many existing display systems can be avoided. Sequential color artifacts, such as color separation artifacts can also be avoided.

It will be appreciated by those of skill in the art that a new and useful imaging system and a method of using the same have been described herein. In view of the many possible embodiments, however, it should be recognized that the embodiments described herein with respect to the drawing figures are meant to be illustrative only and should not be taken as limiting the scope of what is claimed. Those of skill in the art will recognize that the illustrated embodiments can be modified in arrangement and detail. Therefore, the devices and methods as described herein contemplate all such embodiments as may come within the scope of the following claims and equivalents thereof.

I claim:

1. A method of displaying an image, comprising:
providing a light valve comprising an array of light valve pixels;
configuring the light valve pixels such that each light valve pixel in a group represents a discrete grayscale level; and
imaging the light valve pixels on a screen such that a screen pixel has a perceived grayscale level that is an addition of grayscale levels represented by the group of light valve pixels.

2. The method of claim 1, wherein the light valves are operated at a binary mode wherein each pixel of the light valve is capable of being operated at an ON state and an OFF state.

3. The method of claim 1, wherein the step of imaging further comprises:
imaging the light valve pixels on a first group of screen pixels on the screen at a first time; and
imaging the light valve pixels on a second group of screen pixels on the screen at a second time, wherein the first and second groups are adjacent.

4. The method of claim 2, further comprising:
updating the light valve pixels before imaging the light valve pixels on a second row of screen pixels on the screen at a second time.

5. The method of claim 3, wherein the first group of screen pixels are along a first row of screen pixels; and the second group of screen pixels are along a second row of screen pixels.

6. The method of claim 5, wherein the light valve pixels in a column are imaged onto substantially single screen pixel at a time.

7. The method of claim 3, wherein the first group of screen pixels are along a first column of screen pixels; and the second group of screen pixels are along a second column of screen pixels.

8. The method of claim 3, wherein the first group of screen pixels are a first group of rows of screen pixels with each light valve pixel corresponding to a screen pixel; and wherein the second group of screen pixels are a second group of rows of screen pixels with each light valve pixel corresponding to a screen pixel.

9. The method of claim 3, wherein the step of configuring the light valve pixels further comprises:
providing illumination light; and
projecting the illumination light onto the light valve pixels such that light valve pixels are illuminated by different light intensities.

10. The method of claim 3, wherein the step of configuring the light valve pixels further comprises:
configuring the light valve pixels such that at least two light valve pixels represent different grayscales of different colors.

11. The method of claim 1, wherein the light valve is a spatial light modulator; and the pixels of the spatial light modulator are reflective micromirrors or liquid-crystal-on-silicon pixels.

12. The method of claim 1, wherein the step of imaging the light valve pixels on a screen further comprises:
directing the light from the light valve pixels onto an optical element; and
projecting the light from the light valve pixels by the optical element onto the screen.

13. The method of claim 12, wherein the optical element comprises a polygonal mirror having a number of reflective facets.

14. The method of claim 1, wherein the group of pixels are a row or a column of pixels in the array.

15. A video displaying system, comprising:
a light source providing light;
a light valve comprising an array of individually addressable pixels;
a scanning mechanism disposed for causing the light from the light valve pixels to scan a screen;
an image processing unit connected to a video source containing a video stream such that the video stream can be displayed on the screen.

16. The system of claim 15, wherein the scanning mechanism comprises a rotatable polygon having a set of reflective facets.

17. The system of claim 15, wherein the light valve pixels are non-diffractive light valve pixels.

18. The system of claim 15, wherein the light valve pixels are divided into a plurality of pixel groups such that the light valve pixels in each group represent a grayscale level; and the light valve pixels in different groups represent different grayscale levels.

19. A method of producing an image, comprising:
providing a light valve comprising first and second groups of individually addressable pixels;
illuminating the light valve such that the light valve pixels of the first and second groups receive light of different colors;
causing the light from the light valve pixels in the first and second groups to illuminate a first row of image pixels on a screen such that the image pixels in said first row has a first illumination color and intensity distribution across the image pixels in said first row; and
moving the light from the first and second light valve pixel rows onto a second image pixel row such that the image pixels in said second row has a second illumination color and intensity distribution across the image pixels in said second row.

20. The method of claim 19, wherein the first and second intensity distributions across the image pixel rows are different.

21. The method of claim 19, wherein the step of causing the light from the light valve pixels comprises:
directing the light from the light valve pixels onto a movable reflective mirror that reflects said light onto the screen.

22. The method of claim 21, wherein the movable reflective mirror is a facet of a rotatable polygonal mirror.

23. The method of claim 29, wherein the step of moving the light from the first and second light valve pixel rows comprises:
changing an operation state of a light valve pixel in the first or the second row.

24. A method of producing a color image, comprising:
illuminating an array of individually addressable pixels of a light valve by an illumination light that comprises red, green, and blue colored light components; and
directing red, green, and blue light components from the light valve onto a movable reflective mirror so as to scan a viewing screen with the red, green, and blue light components, wherein groups of light valve pixels are illuminated by respective red, green, and blue colored lights from the movable reflective mirror, wherein light from each group of light valve pixels is spatially combined to form a corresponding image pixel on the viewing screen.

25. The method of claim 24, wherein the illumination light are laser light.

26. The method of claim 24, wherein the illumination intensity of said image pixel is an addition of the light from different light valve pixels.

27. The method of claim 24, wherein the color of the light illuminating said image pixels is an addition of the colors of the light from different light valve pixels.

28. The method of claim 24, wherein red, green, and blue colored light are simultaneously incident onto the light valve pixels.
